(19) United States
(12) Patent Application Publication
(10) Pub. No.: US 2012/0284618 A1
(43) Pub. Date: Nov. 8, 2012

(54) DOCUMENT BASED CONTEXTUAL COMMUNICATION

(75) Inventors: Jonathan Bailor, Bellevue, WA (US); Christopher Schindler, Sammamish, WA (US); Nicholas Simons, Redmond, WA (US)

(73) Assignee: Microsoft Corporation, Redmond, WA (US)

(21) Appl. No.: 13/102,553

(22) Filed: May 6, 2011

(51) Int. Cl. G06F 17/24

(52) U.S. Cl. 715/255

(57) ABSTRACT

A service that is capable of tracking conversations related to documents, surfaces these documents appropriately to users and enables user-friendly notification of new communications associated with the discussed documents while respecting existing user experience, security, and privacy models of the various document and communication modalities. Conversations about particular content are made available within the context of that content through user interface elements that not only provide access to various communication modes, but also present discussion context in summary or detailed versions.

### BACKGROUND

With the proliferation of computing devices and networked communications, document and data sharing has become a common place in business and personal environments. In addition to tools that enable people to comment, version, and exchange documents through locally installed applications, hosted services enable shared creation and processing of documents.

Communication capabilities have also expanded by leaps and bounds compared to conventional communication mechanisms allowing people to exchange quick text messages, establish online conferences, share desktops, documents, and applications through a wide variety of stationary and portable computing devices. Indeed, people continuously communicate using instant messaging, email, audio communications, video communications, and similar modalities. Such communications may center around select documents or fragments of documents. For example, one person may send a text message regarding a paragraph in a document, while another may respond with an email that includes a commented version of the entire document attached to the email. Yet another person in the group discussing the document may place an audio or video call to another member (or all members) of the group with additional comments. A major source of frustration may be the contextual disconnect between these communications and the discussed content.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a service that is capable of tracking conversations related to documents, surfacing these documents appropriately to users, and enabling user-friendly notification of new communications associated with the discussed documents. According to some embodiments, conversations about particular content may be made available within the context of that content through user interface elements that not only provide access to various communication modes, but also present discussion context in summary or detailed versions.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating example communications centering around one or more documents coordinated by a service;

FIG. 2 illustrates major components and interactions between those in a system providing document based contextual communications;

FIG. 3 illustrates two example user interfaces of a document processing application that enables activation of different communication modalities from within the user interfaces and presentation of comments on the displayed document;

FIG. 4 illustrates two additional user interfaces of a document processing application that enables activation of different communication modalities from within the user interfaces and presentation of comments on the displayed document integrated with the communication capabilities;

FIG. 5 illustrates an example communications application user interface enabling document based contextual communications;

FIG. 6 is a networked environment, where a system according to embodiments may be implemented;

FIG. 7 is a block diagram of an example computing operating environment, where embodiments may be implemented; and

FIG. 8 illustrates a logic flow diagram for a process of providing document based contextual communication according to embodiments.

### DETAILED DESCRIPTION

As briefly described above, conversations related to documents may be tracked, the documents surfaced appropriately to users, and user-friendly notification of new communications associated with the discussed documents enabled. Conversations about particular content may be made available within the context of that content through user interface elements that not only provide access to various communication modes, but also present discussion context in summary or detailed versions. Furthermore, conversations may be started or added from within a document through additional user interface elements. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable storage media.

Throughout this specification, the term “platform” may be a combination of software and hardware components for providing document based contextual communication services for various document types or similar environment, where embodiments may be implemented. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

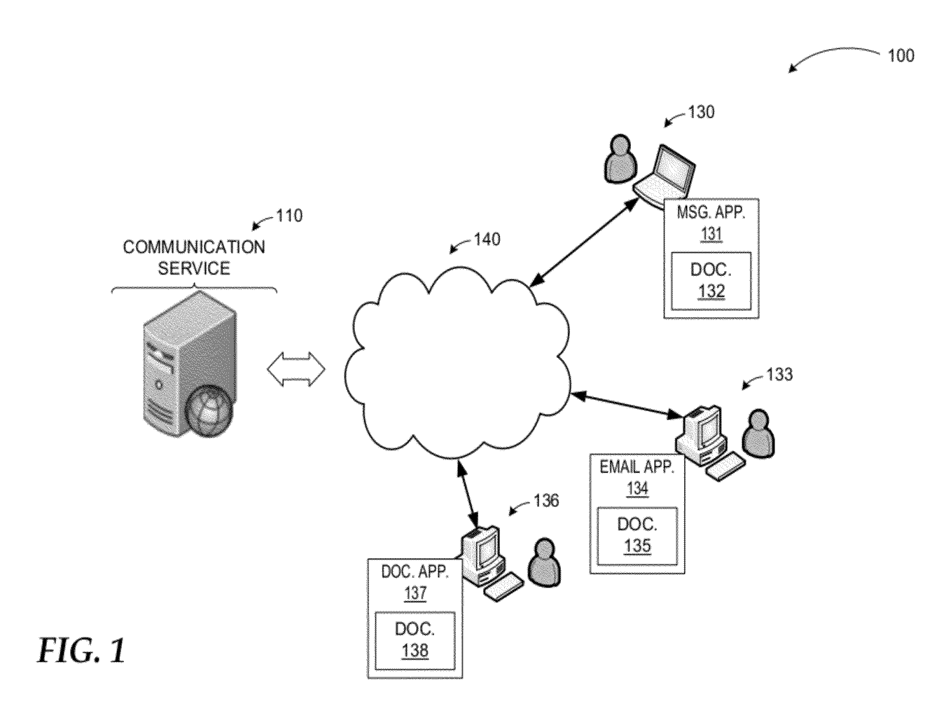

FIG. 1 is a conceptual diagram illustrating example communications centering around one or more documents coordinated by a service. In diagram 100, the server 110 may execute one or more communication services enabling users to communicate using various modalities through client devices 130, 133, and 136 via network 140. The network 140 may be a local network or may be an external entity such as an internet based infrastructure. It may provide wired or wireless connectivity. Network nodes may connect to each other through unsecured or secured connectivity. An example of a secured connectivity may be a Virtual Private Network (VPN) established among the network nodes with the use of encrypted communications.

Client devices 130, 133, and 136 may execute various applications such as messaging application 131, email application 134, and document processing application 137, respectively. In other embodiments, audio and/or video communication applications may also be executed by the client devices for document based contextual conversation. Users may exchange comments, whole documents, or document fragments through contextual conversations. As indicated by the different applications, the conversations may take various forms and be initiated with the context provided through the respective applications' user interfaces. Each user may have the same document or different versions of the document (e.g., 132, 135, 138), or different documents. Through specific Application Programming Interfaces (APIs), the communication service may enable threaded comments (public or private type), flagging, tagging, filtering, sorting, etc. across user interfaces, and launching of new conversations with the context or addition of the context to existing conversations. Threads may be single or multi-level.

The conversations may be presented through each user's personal view based on a query of the communication service. In some embodiments, a communication application such as a text messaging application, an email application, an audio conversation application (e.g., a Voice over IP, “VoIP” call), a video conversation application, an online conference application, etc. may be launched from within a user interface of a document processing application such as a word processing application, a presentation application, a spreadsheet application, a database application, a charting application, a browsing application, etc. In other embodiments, a document viewing or editing user interface may be provided from within the user interface of a communication application user interface as part of the context. Additional information such as location, position, participants (in the discussion on the document), and comparable data may be presented as part of the context.

According to further embodiments, conversations may be annotated such that conversation headers and annotations are persisted in a file, associated conversations may be tracked by the communication service, and views (i.e. document processing vs. communication user interfaces) may be easily switchable enabling a user friendly collaboration environment. Alternatively, the service may enable dissociation of a conversation from a document that provides context and/or change parts or all of a conversation associated with a document from public to private or from private to public. Moreover, the conversation(s) may be real time or delayed.

According to an example scenario, an author may create a document and send a “please review this” message to his team from within the document processing application user interface with a few key areas specifically called-out for “deep” review. The user interface may include controls for activating various communications such as email, phone conversation, text messaging, or comparable modalities. Clicking email may launch a new email with the comment and selected text and/or attach the file or insert a link (depending on local or server file) with a bookmark to the given region. If the author wants to direct his communication to particular recipients, he/she may select the recipients from a people list that may be presented through textual and/or graphical scheme and/or include additional information such as presence information.

One of the recipients may respond with an email, while another may insert his/her reply into the file. Upon receiving the comments/commented file, which includes all communications regardless of modality, the author may activate a contextual user interface (by clicking on a control or hovering over a particular region of the user interface) and be presented with the contextual information such as a structured listing of the comments (e.g. a collapsible tree structure) along with additional information such as who the comments are from, when they were made, etc. Commented sections of the document may be indicated (and tied to the comments) through a color scheme, shading scheme, graphic scheme, etc.

The author (or one of the recipients) may also insert notes resulting from an audio or video conversation into the context user interface or the document itself persisting the context along with the document. The audio/video conversation may also be initiated from within the document processing user interface.

The document review experience is thereby enhanced by contextually requesting feedback, routing that feedback to the appropriate individuals, and making it easy to sort/filter/pivot the results, creating documents with rich communication histories paired with the content.

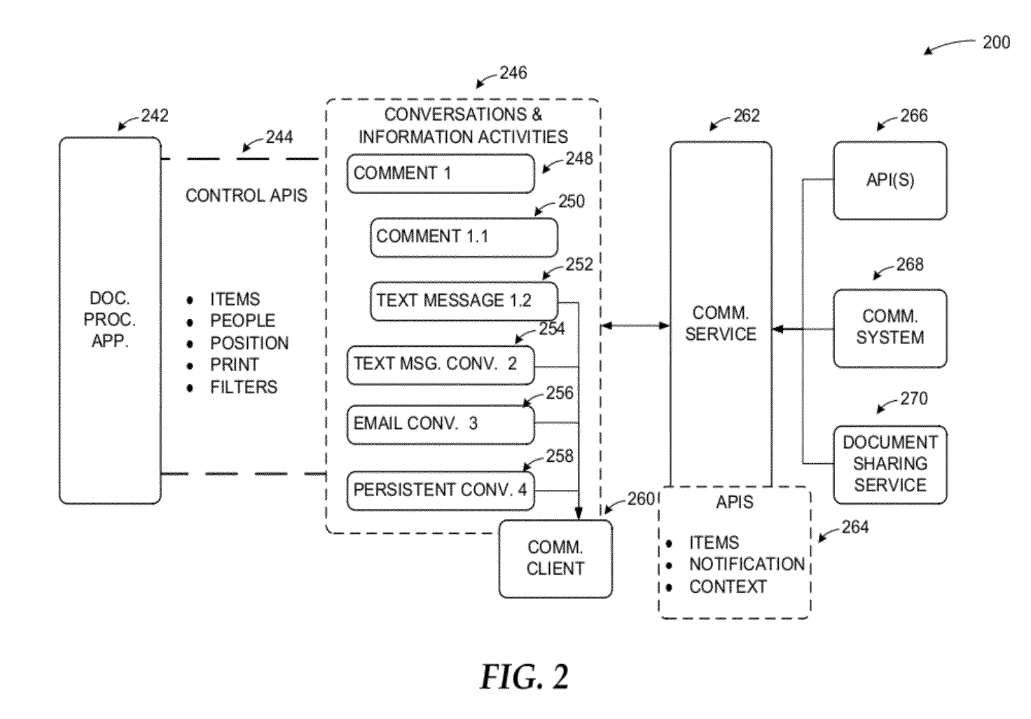

FIG. 2 illustrates major components and interactions between those in a system providing document based contextual communications. A system according to embodiments may be implemented with a variety of document processing or communication applications and may include, depending on the configuration, a number of different APIs to facilitate the contextual communications. Diagram 200 illustrates some of the example components and configurations.

In the example system of diagram 200, communication service 262 facilitates conversations and information activities 246 with document processing application 242 through control APIs 244. Control APIs 244 may include interfaces for items (e.g., create, delete, update, move, find), people (e.g., author, contributor, reviewers), position (e.g., current, type), print (e.g., comments), and/or filters (e.g., read/unread, time, position). Document processing application 242 may include a control user interface (graphical and/or textual), a hosting space, read/write to file capability, an anchoring user interface, display/print logic, and/or a print user interface, among other features.

Conversations and information activities 246 may provide comments (e.g., comment 1 (248), comment 1.1 (250)), text messages (e.g., text message 1.2 (252), text message conversation 2 (254)), emails (e.g., email conversation 3 (256)), and/or persistent conversations 258 to communication client applications such as communication client 260. As part of the group conversation framework, application specific APIs 266, communication system 268, and document sharing system 270 may coordinate with communication service 262 through APIs 264 such as interfaces for items, notification, and context. Other components may also be included in various configuration of such an example system.

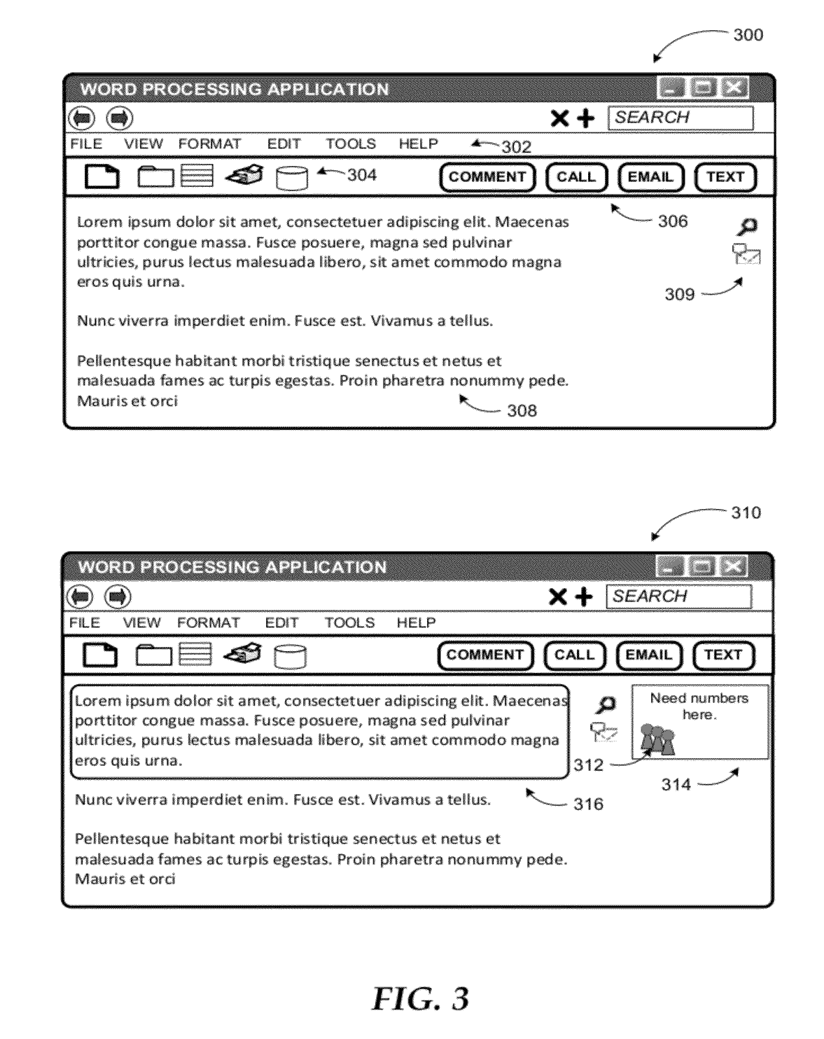

FIG. 3 illustrates two example user interfaces of a document processing application that enables activation of different communication modalities from within the user interfaces and presentation of comments on the displayed document.

User interface 300 is for a word processing application and may include textual drop-down menus 302 and graphical control elements 304. Text 308 may be edited/commented by one or more authors and used for context in collaborative conversations. Various modes of conversation may be activated through controls 306 within the word processing application's user interface 300. Graphical elements 309 may provide additional functionality such as access to different modalities (comment, email, text messaging) may all be all captured in the document application UI.

User interface 310 includes a selected section 316 of the text for which an author of the document may be requesting comments from other participants of the discussion on the document. To solicit comments, the author may activate a context user interface 314, which may include the author's comment as well as graphical control 312. Graphical control 312 may enable the author to see a listing of participants, select one or more, and select a conversation mode for soliciting the comments. Privacy and security concerns may be addressed by making the conversations viewable only to those in the conversation even when the conversation is part of the document.

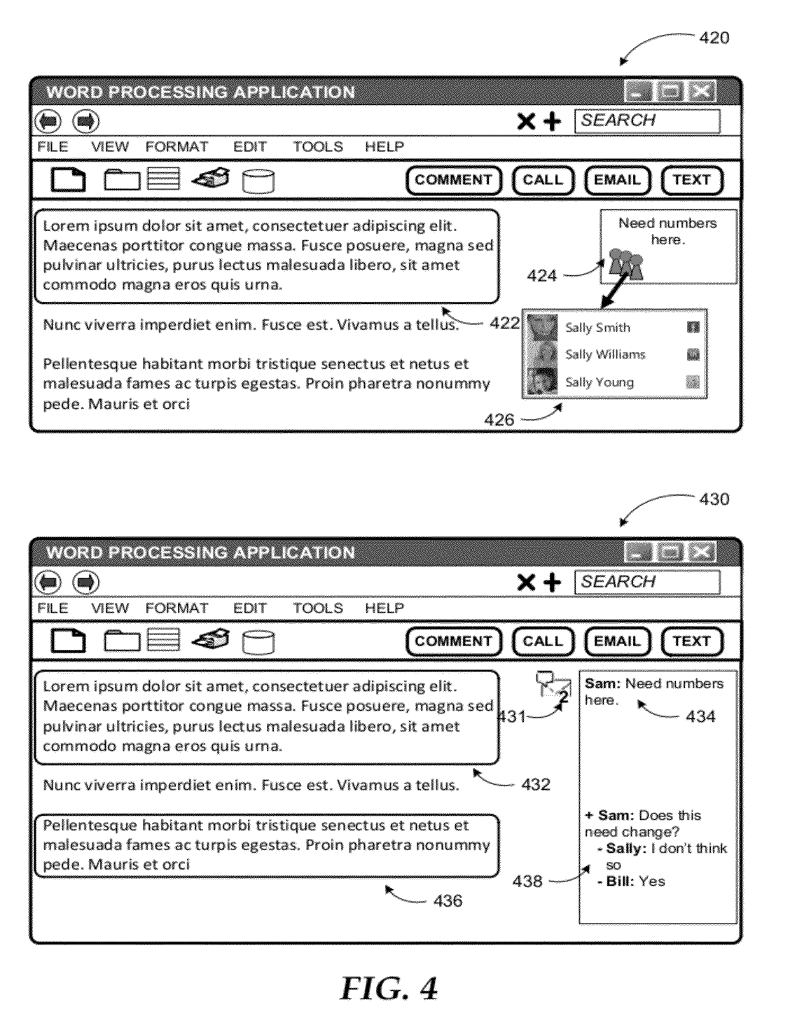

FIG. 4 illustrates two additional user interfaces of a document processing application that enables activation of different communication modalities from within the user interfaces and presentation of comments on the displayed document integrated with the communication capabilities.

User interface 420 shows the example user interface 310 of FIG. 3 with the graphical control 424 for selecting participants activated (e.g., by clicking on it). A sub-user interface 426 may be presented providing information (e.g., presence information) for the participants. Available communication modes may be presented along with each participant listed in the sub-user interface 426. Depending on the selected conversation mode and author preference, the selected section 422 of the text, the entire document, or just the author's comments may be included in the conversation going out to the selected participants.

Example user interface 430 shows the document after several participants have provided comments and the context is persisted. Section 432 of the text is selected by the original author (Sam), while section 436 is selected in a response comment by another participant. Context user interface displays a summary of the discussion on the document in a structured format with the original author's first comment 434 at the top and the responses or other comments 438 at the bottom of the context user interface in a collapsible tree structure. Graphical control 431 indicates that the conversation included two emails providing access to those emails through the document application user interface. In other examples, other graphical controls may be displayed showing other parts of the conversation (e.g., text messages, phone calls, etc.).

Example embodiments are illustrated herein with specific applications, communication modalities, document types, and systems. These are not to be construed as limitations on embodiments, however. Different aspects of the present disclosure may be implemented with other programming applications, communication modalities, document types, and systems using the principles described herein,

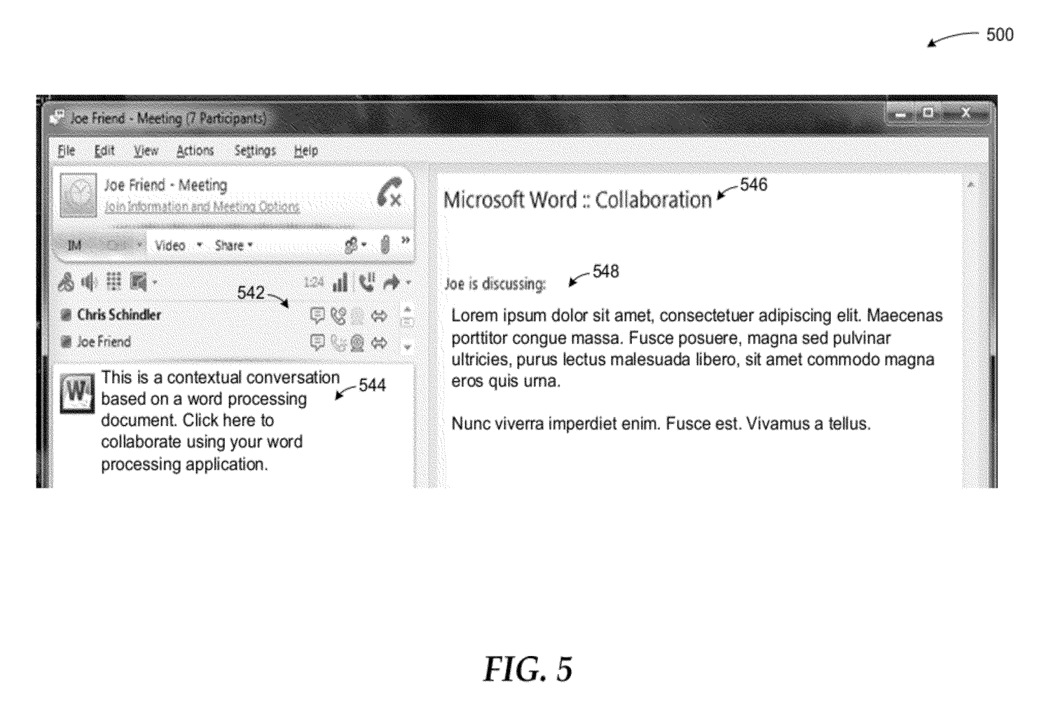

FIG. 5 illustrates an example communications application user interface enabling document based contextual communications. Example user interface 500 may facilitate text messaging, audio communications, video communications, or similar modalities. As such, it includes textual and/or graphical control elements 542 to activate various forms of communication.

In a system according to embodiments, the user interface 500 may have a section 546 dedicated to document based contextual collaboration. In section 546, a summary (or entirety) of the comments may be listed such as comment 548. Furthermore, a representation 544 of the document, which is at the center of the collaboration effort, may be displayed with a link such that the document may be opened in a word processing or similar user interface for further actions.

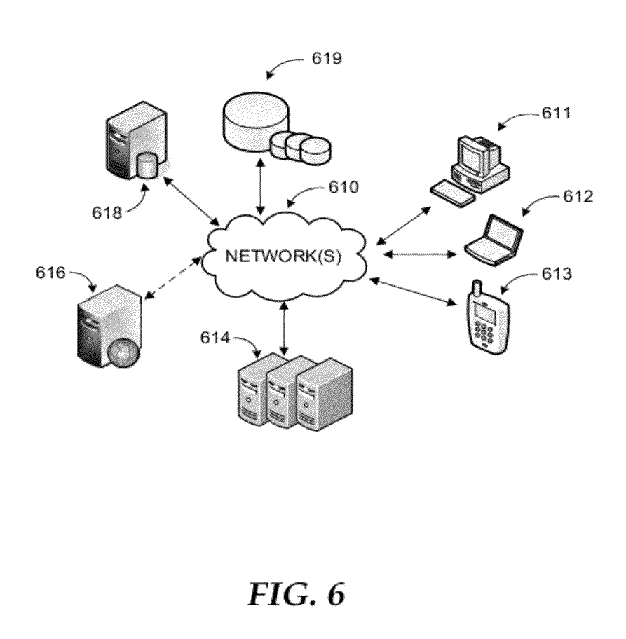

FIG. 6 is an example networked environment, where embodiments may be implemented. A service providing contextual communication based on documents may be implemented via software executed over one or more servers 614 or a single server (e.g. web server) 616 such as a hosted service. The platform may communicate with client applications on individual computing devices such as a smart phone 613, a laptop computer 612, or desktop computer 611 (‘client devices’) through network(s) 610.

As discussed above, hosted or locally installed client applications (on client devices 611-613) may enable activation of various modalities of communication from within user interfaces associated with document processing applications along with presenting contextual information and/or content providing the context may be included wholly or partially within communication user interfaces with users being enabled to select comments and communications in a coordinated manner.

Client devices 611-613 may enable access to applications executed on remote server(s) (e.g. one of servers 614) or receive contextual communication capability for locally installed applications from the service as discussed previously. The server(s) may retrieve or store relevant data from/to data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to provide document based contextual communications. Furthermore, the networked environments discussed in FIG. 6 are for illustration purposes only. Embodiments are not limited to the example applications, modules, or processes.

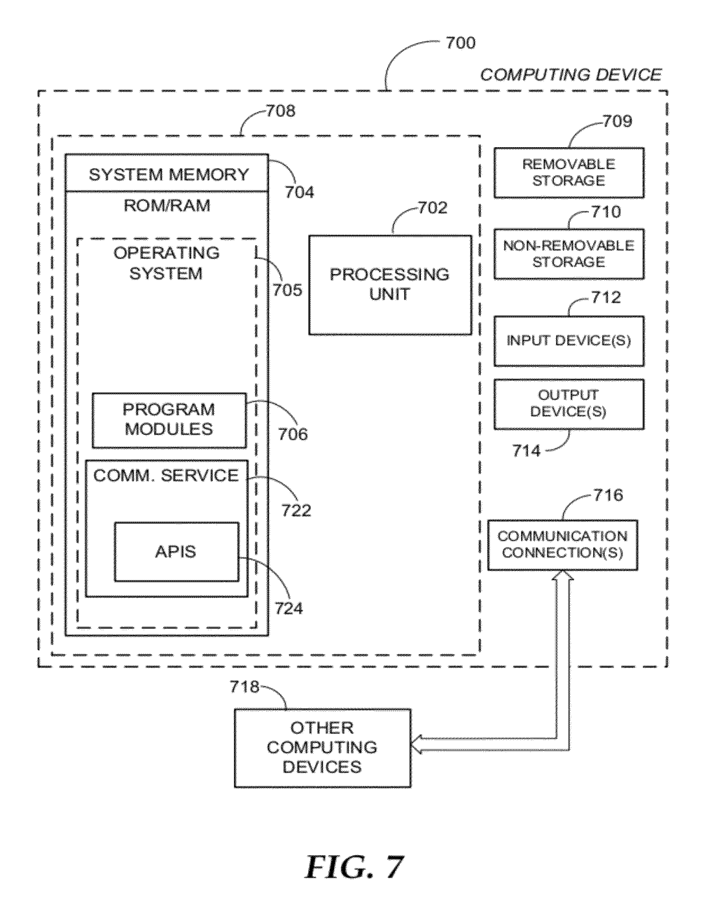

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as computing device 700. In a basic configuration, computing device 700 may be a server and include at least one processing unit 702 and system memory 704. Computing device 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of the platform, such as the WINDOWS® operating systems from MICROSOFT CORPORATION of Redmond, Washington. The system memory 704 may also include one or more software applications such as program modules 706, communication service 722, and APIs 724.

Communication service 722 may enable communication in various modalities between client devices. Through APIs 724, communication service 722 may enable hosted or locally installed document processing applications to initiate or continue contextual conversations based on presented documents, exchange comments/documents/fragments of documents from within the same user interface (document processing application or communication application user interface). This basic configuration is illustrated in FIG. 7 by those components within dashed line 708.

Computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer readable storage media may be part of computing device 700. Computing device 700 may also have input device(s) 712 such as keyboard, mouse, pen, voice input device, touch input device, and comparable input devices. Output device(s) 714 such as a display, speakers, printer, and other types of output devices may also be included. These devices are well known in the art and need not be discussed at length here.

Computing device 700 may also contain communication connections 716 that allow the device to communicate with other devices 718, such as over a wireless network in a distributed computing environment, a satellite link, a cellular link, and comparable mechanisms. Other devices 718 may include computer device(s) that execute communication applications, storage servers, and comparable devices. Communication connection(s) 716 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

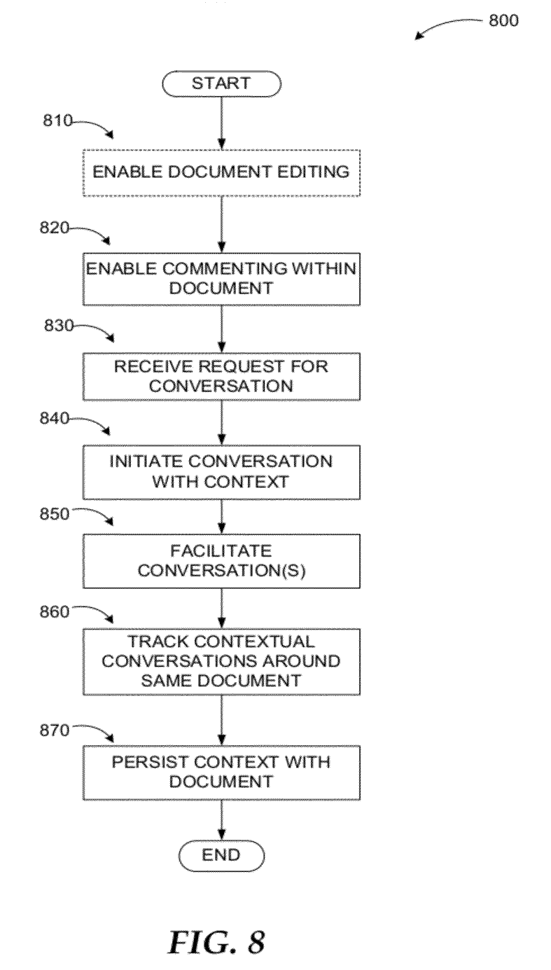

FIG. 8 illustrates a logic flow diagram for process 800 of a process of providing document based contextual communication according to embodiments. Process 800 may be implemented by a server hosting a communication service or a document processing application associated with one or more communication services.

Process 800 begins with optional operation 810, where a user is enabled to edit a document through a document processing user interface. At operation 820, the user may be enabled to comment within the document. Upon receiving a request for initiating a conversation from the user 830, the service or document processing application may initiate the conversation providing a context to the conversation based on the document. For example, a fragment of the document selected by the user may be inserted into a text message or the entire document with the selected fragment highlighted attached to an email message.

At operation 850, the conversation(s) may be facilitated enabling exchange of text messages, emails, audio communications, etc. between participants of the discussion group each exchange including context such as comments, document fragments, etc. At operation 860, the service may track the conversation(s) around the same document persisting the context with the document at operation 870 such that the context is rendered along with the document, where the rendered context is filtered based on access permissions. According to other embodiments, the conversation(s) may be initiated through communication application user interface(s) that provide sub-user interfaces for viewing/editing the document and/or the contextual information (e.g., comments, selections, etc.).

According to further embodiments, dissociation of a conversation from a document used as context for the conversation, categorization of one or more portions of a conversation as private with restricted access, and/or categorization of one or more portions of another conversation as public with unrestricted access may be enabled. The context may include a single or multi-level threaded list of comments that may be presented as a collapsible list. As mentioned previously, color, shading, textual, graphical, and similar schemes may be used to correlate selected sections of the document with comments or other context information.

The operations included in process 800 are for illustration purposes. Contextual communications based on documents according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part by a computing device for enabling document based contextual communications, the method comprising:
enabling at least one of editing and commenting of a document through a document user interface;
in response to receiving an indication of a conversation request through the document user interface initiating a conversation from within the document user interface providing a context for the conversation based on the document;
tracking one or more conversations associated with the document as the conversations are facilitated; and
persisting the context for the conversations with the document subject to at least one security rule.

2. The method of claim 1, further comprising:
presenting the context of the conversations in a context user interface that is one of attached and integrated to the document user interface.

3. The method of claim 2, wherein the presented context of the conversations includes a threaded list of comments on a plurality of sections of the document.

4. The method of claim 3, further comprising:
employing at least one from a set of: a color scheme, a shading scheme, a textual scheme, and a graphical scheme to correlate the commented sections of the document and the context user interface.

5. The method of claim 1, further comprising:
enabling at least one from a set of: flagging, tagging, filtering, and sorting within the document across different communication user interfaces.

6. The method of claim 1, wherein the conversations include at least one from a set of: an email exchange, a text message exchange, an audio conversation, a video conversation, and a conference session.

7. The method of claim 1, wherein providing the context for the conversation includes:
enabling insertion of at least one from a set of: a document fragment, the document as an attachment, and a link to a specific location in the document into one of a text message and an email message.

8. The method of claim 1, further comprising:
enabling at least one from a set of: dissociation of a conversation from a document used as context for the conversation, categorization of one or more portions of a conversation as private with restricted access, and categorization of one or more portions of another conversation as public with unrestricted access.

9. The method of claim 1, further comprising:
persisting the context as part of the document file such that the context is rendered along with the document, wherein the rendered context is filtered based on access permissions.

10. The method of claim 1, wherein the conversations are one of online and offline conversations.

11. A server providing a communication service with document based contextual communication, the server comprising:
a memory;
a processor coupled to the memory, the processor executing an application associated with the communications service in conjunction with instructions stored in the memory, wherein the communication service is configured to:
enable initiation of one or more conversations from within a document user interface facilitating at least one of editing and commenting of the document, wherein the conversations include a context based on the document;
annotate the conversations with the context associated with the document such that conversation headers and annotations are persisted; and
render the context in a context user interface associated with the document user interface.

12. The server of claim 11, wherein the document user interface is provided by a document processing application and each conversation is facilitated by a communication client application in conjunction with the communication service.

13. The server of claim 12, wherein a plurality of Application Programming Interfaces (APIs) are employed to exchange information between the document processing application and the communication client application, the APIs including at least one from a set of: an items API for create, delete, update, move, find actions; a people API for author, contributor, reviewer attributes; a position API for current and type attributes; and a print API for comments.

14. The server of claim 11, wherein the communication service is further configured to enable a user to one of edit and view the document through a communication user interface facilitating a conversation.

15. The server of claim 11, wherein the conversations are facilitated by one or more of: a text messaging application, an email application, an audio conversation application, a video conversation application, and an online conference application.

16. The server of claim 11, wherein the document and the context are rendered by one of: a word processing application, a presentation application, a spreadsheet application, a database application, a charting application, and a browsing application.

17. A computer-readable storage medium with instructions stored thereon for enabling document based contextual communications, the instructions comprising:
enabling initiation of one or more conversations from within a document user interface for facilitating at least one of editing and commenting of the document, wherein the conversations include a context based on the document;
annotating the conversations with the context based on the document such that conversation headers and annotations are persisted; and
render the context in a context user interface associated with the document user interface employing controls for initiating additional conversations and viewing comments.

18. The computer-readable storage medium of claim 17, wherein the instructions further comprise:
presenting multi-threaded comments on the document employing a collapsible tree structure.

19. The computer-readable storage medium of claim 17, wherein the instructions further comprise:
enabling insertion of at least one from a set of: a document fragment, the document as an attachment, and a link to a specific location in the document into an exchange depending on a conversation type.

20. The computer-readable storage medium of claim 17, wherein the instructions further comprise:
enabling persistence of the context comprising comments, changes to the document, and reviewer information along with the document as one of: a part of the document and a separate file associated with the document.
